(19) United States
(12) Patent Application Publication
(10) Pub. No.: US 2026/0168881 A1
(43) Pub. Date: Jun. 18, 2026

(54) CARRIER GAS LEAK DETECTION SYSTEM, AND CARRIER GAS LEAK DETECTION METHOD FOR LEAK DETECTION ON A TEST PIECE

(71) Applicant: INFICON GMBH, Köln (DE)

(72) Inventors: Daniel WETZIG, Köln (DE); Maximilian REISMANN, Köln (DE); Hjalmar BRUHNS, Köln (DE)

(73) Assignee: INFICON GMBH, Köln (DE)

(21) Appl. No.: 19/126,171

(22) PCT Filed: Oct. 2, 2023
(86) PCT No.: PCT/EP2023/077236

§ 371 Date: Apr. 30, 2025

(30) Foreign Application Priority Data
Nov. 11, 2022 (DE) 10 2022 129 858.2

(51) Int. Cl. G01M 3/20

(52) U.S. Cl. CPC G01M 3/205

(57) ABSTRACT

A carrier gas leak detection system for leak detection on a test specimen, including a gas detector, a test chamber having at least a first test chamber inlet, a test chamber outlet and a test chamber vacuum pump evacuating the test chamber outlet, a first gas line connecting the test chamber outlet to the detector volume inlet and the test chamber vacuum pump in a gas-conducting manner, a second flow throttle for presetting the carrier gas flow through the first test chamber inlet, a second gas line connecting the test chamber outlet to the test chamber vacuum pump parallel to the first gas line, a third flow throttle in a detector section of the first gas line between a first connection point and the detector volume inlet, and a fourth flow throttle in the second gas line between the test chamber outlet and the first connection point.

For integral leak testing with test gas, test specimens are tested in a test chamber using test gas vacuum leak detection. For this purpose, the test specimen filled with a test gas is placed in a test chamber, which is then evacuated. The test gas partial pressure is measured in the vacuum system using a test gas detector. Test gas, which flows through a leak from the test specimen into the test chamber, can be actively guided to the test gas detector with a carrier gas. For this purpose, the carrier gas is continuously introduced into the test chamber and pumped out with the vacuum system so that an equilibrium working pressure is formed in the test chamber. With the resulting carrier gas flow, test gas escaping from the test specimen is transported to the test gas detector. The presence or the measured signal strength is a measure of the leakage rate at the test specimen. Different detectors are used to detect the test gas, depending on the detection limit required. A quadrupole mass spectrometer is used to achieve a very high test gas sensitivity. The QMS has both a very high sensitivity and a high selectivity.

In principle, the carrier gas method can also be used with other types of detectors that do not necessarily have to be operated in a vacuum or high vacuum, such as optical detectors or surface sensors.

The maximum sensitivity is achieved at an optimum total pressure of 1E-4 mbar in the ion source. A lower working pressure in the detection volume causes a lower sensitivity due to the lower number of molecules or atoms to be detected and a higher working pressure causes a reduction in sensitivity due to losses of charge carriers caused by space charge effects. If the density of electrically charged particles in the ion source space is too high, the charge carriers repel each other too strongly.

This optimum working pressure is achieved with the fixed suction capacity at the QMS detection volume and fixed conductance of the pressure transducer inlet (e.g. capillary) for a specific inlet pressure. A deviation from this optimum inlet pressure generally has a quadratic effect on the total pressure in the ion source.

For example, halving the inlet pressure results in a reduction of the total pressure in the high vacuum to a quarter of the original value. The sensitivity of the system scales with decreasing pressure in the ion source, i.e. a change in pressure at the inlet to the mass spectrometer reduces the sensitivity of the system disproportionately.

In the carrier gas method, the carrier gas flow rate is to be adapted to the amount of gas present in the test chamber. The aim here is to exchange the gas volume in the chamber approximately two to three times (2-3 tau) in as short a period as possible in order to achieve a convergence value for the leakage signal.

In principle, the pressure in the test chamber can be lowered to reduce the amount of gas to be exchanged. However, this means that additional time is required to pump out the chamber and higher costs result for the pumping system.

Accordingly, the carrier gas flow must be increased for larger test chambers (larger net chamber volume) and reduced for smaller net volumes.

As the carrier gas flow changes, the equilibrium pressure in the test chamber also changes.

It is desirable to adapt the working pressure at the gas detector, e.g. in the detector volume of the mass spectrometric gas detector, especially in the case of a quadrupole mass spectrometer, to a changing working pressure in the test chamber. This also applies to other types of detectors. The working pressure in the test chamber depends on the amount of carrier gas introduced into the test chamber and the suction capacity of the pump used to evacuate the test chamber. This pump is referred to below as a test chamber vacuum pump. Adapting the working pressure in the detector volume or at the detector via the suction capacity of the vacuum pump requires a great deal of technical effort and is therefore not very practical. In the case of a vacuum detector, the vacuum pump evacuating the detector volume is referred to below as the detector vacuum pump.

Against this background, the object of the invention is to provide a system and a method for leak detection on a test specimen by carrier gas leak detection, in which the flow rate of the carrier gas at the gas detector and the pressure in the test chamber can be adapted with little technical effort.

The leak detection system according to the invention is defined by the features of claim 1. The leak detection method according to the invention is defined by the features of claim 13.

The carrier gas leak detection system according to the invention comprises a gas detector and a test chamber. The test chamber comprises a test chamber volume into which at least a first test chamber inlet and a test chamber outlet open, wherein a test chamber vacuum pump evacuating the test chamber volume is connected to the test chamber outlet. The test chamber outlet is connected to the gas detector and the test chamber vacuum pump in a gas-conducting manner via a first gas line in order to supply the gas to be analyzed from the test chamber to the detector.

The gas detector can comprise a detector volume inlet with a first flow throttle for pressure conversion at the detector volume inlet. The first flow throttle can be a suitable cross-sectional configuration of the detector volume inlet, for example.

Depending on the type of detector, the first flow throttle is not absolutely necessary. A second flow throttle is provided to supply carrier gas into the test chamber volume at the test chamber inlet. The second flow throttle can comprise an adjustable conductance for changing the carrier gas flow.

A second gas line connecting the test chamber outlet to the gas detector parallel to the first gas line is connected to the test chamber vacuum pump and to the first gas line in a gas-conducting manner at a first connection point. A third flow throttle is provided in a detector section of the first gas line between the first connection point and the gas detector. A fourth flow throttle is provided in the second gas line between the test chamber outlet and the first connection point. The third flow throttle and the fourth flow throttle therefore form a flow divider together with the first and second gas lines in such a way that a first partial flow can be evacuated through the second gas line and a second partial flow through the first gas line from the test chamber using the test chamber vacuum pump.

The third flow throttle is provided in the first gas line between the first flow throttle and the test chamber vacuum pump for adjusting the pressure in the first gas line. The third flow throttle can have an adjustable conductance. With the third flow throttle, the pressure at the gas detector can be preset or selectively adjusted manually or automatically by a pressure control device. The second flow throttle can be used to specify or change the carrier gas flow supplied to the test chamber.

The fourth flow throttle is provided in the second gas line between the test chamber outlet and the test chamber vacuum pump. With the fourth flow throttle, the suction capacity can be specified or adjusted, with which the test chamber vacuum pump draws carrier gas into the test chamber volume. The test chamber vacuum pump is connected to the first and second gas lines between the third flow throttle and the fourth flow throttle in the first connection point so that the main gas flow of the carrier gas passes through the second flow throttle, the test chamber inlet through the test chamber volume and from the test chamber outlet through the fourth flow throttle into the test chamber vacuum pump. The suction capacity at the test chamber specified by the fourth flow throttle together with the third flow throttle defines the pressure in the test chamber for a given carrier gas flow.

The fourth flow throttle can also have an adjustable conductance in order to change the carrier gas flow and/or the pressure in the test chamber and/or to selectively adjust it manually or automatically by a pressure control device, for example.

The first, second, third and/or fourth flow throttle each define the gas conductance of the respective line section and can be specified, for example, by an aperture, by a capillary or by the conductance, the cross-section or the diameter of the respective section of the gas line.

With the aid of the third and fourth flow throttles, the gas flow drawn in from the test chamber by the test chamber vacuum pump can be divided according to the invention. The third and fourth flow throttles thus form a flow divider. One partial flow—referred to below as the first partial flow—travels directly along the first gas line to the test chamber vacuum pump, while the other partial flow—referred to below as the second partial flow—travels along the first gas line past the gas detector to the test chamber vacuum pump. Carrier gas from the second partial flow, which contains test gas in the event of a leak in the test specimen, is supplied to the detector and analyzed there. In the case of a vacuum or high vacuum detector with an evacuated detector volume, such as a mass spectrometer, the detector volume is meanwhile typically continuously evacuated by a detector vacuum pump.

The invention enables leak detection on a test specimen within a test chamber using an adjustable carrier gas flow, with which leakage gas or test gas is continuously transported from the test chamber to the detector, while the required pressure ratios and amounts of gas at the detector and in the test chamber can be selectively adjusted.

In a corresponding manner, the carrier gas leak detection method according to the invention for leak detection on a test specimen is characterized by the following steps:
introducing a test specimen into the test chamber,
evacuating the test chamber with the test chamber vacuum pump,
supplying carrier gas into the test chamber containing the test specimen through the second flow throttle,
evacuating the first and second gas lines with the test chamber vacuum pump,
specifying or adjusting the conductance of the third flow throttle and the fourth flow throttle as a flow divider such that a first partial flow through the second gas line and a second partial flow through the first gas line can be evacuated from the test chamber using the test chamber vacuum pump, and
analyzing gas from the second partial flow with the gas detector.

Preferably, the gas flow along the first partial flow is greater and, in particular, significantly greater than along the second partial flow. The gas flows along the first and second partial flow are specified via the third flow throttle and fourth flow throttle and can be adjusted in the case of flow throttles with variable conductance. The conductance S3 of the third throttle is preferably lower and in particular significantly lower than the conductance S4 of the fourth throttle. Preferably, the conductance S3, S4 can be set, e.g. manually or with the aid of an electronic control device.

Advantageously, a test chamber section of the first gas line between the test chamber outlet and the gas detector or the detector volume inlet is provided with a selectively closable first valve, while the detector section comprises a selectively closable second valve between the first flow throttle and the third flow throttle.

With the help of the first valve and the second valve, the pressure conditions can be kept constant while the test chamber is being pumped out using the test chamber vacuum pump. If the first valve and the second valve are closed, the test chamber can be evacuated by means of a direct connection between the test chamber vacuum pump and the test chamber without the pressure at the detector volume inlet being changed by the pumping process of the test chamber.

The test chamber inlet can be provided with a selectively closable third valve.

The test chamber can have at least one second test chamber inlet for ventilating or flushing the test chamber or the test chamber volume, wherein the second test chamber inlet comprises a selectively closable fourth valve which is only opened for ventilating or flushing.

In particular, the test chamber outlet can be connected directly to the test chamber vacuum pump via a third gas line. The third gas line preferably bridges the second gas line with the fourth flow throttle and a possible sixth valve arranged upstream of the fourth flow throttle. The third gas line can be provided with a selectively closable fifth valve. When the fifth valve is open, the test chamber is evacuated directly via the third gas line, for example to bring it to the required test chamber vacuum pressure after a test specimen has been introduced into the test chamber. This test chamber vacuum pressure is advantageously in the range of a few millibars, for example between 0.1 and 10 mbar. The fifth valve is then closed and the sixth valve is opened in order to convey a continuous flow of carrier gas through the test chamber volume into the second gas line with the aid of the test chamber vacuum pump when the third valve is open. The sixth valve may also be open beforehand, e.g. if the test chamber is evacuated via the third gas line, or may not be present.

The second gas line with the fourth flow throttle and the sixth valve runs parallel to the third gas line with the fifth valve. If the first, second, third and fourth valves are closed, the test chamber can be evacuated directly via the third gas line using the test chamber vacuum pump when the fifth valve is open. As soon as the required test chamber pressure is reached, the fifth valve is closed and the third valve is opened. As a result, carrier gas is drawn into the test chamber volume through the first test chamber inlet and supplied along the second gas line through the open sixth valve and through the fourth flow throttle to the test chamber vacuum pump. Meanwhile, the gas detector can be evacuated using a gas detector vacuum pump.

To start the leakage measurement, the first valve and the second valve are opened so that a partial flow of the carrier gas, which is subsequently referred to as the second partial flow, is supplied along the first gas line past the gas detector and along the detector section of the test chamber vacuum pump. In doing so, the third flow throttle and the fourth flow throttle determine the ratio of the flow division. A first partial flow passes through the second gas line to the test chamber vacuum pump. Carrier gas with possible leakage gas from the test specimen reaches or enters the gas detector from the second partial flow, which is guided past the gas detector along the first gas line, and can be detected there.

The gas detector can be a vacuum gas detector or a mass spectrometric gas detector having a detector volume into which a detector volume inlet and a detector volume outlet open. A detector vacuum pump is connected to the detector volume outlet in a gas-conducting manner in order to evacuate the detector volume to the required vacuum pressure. Alternatively, the gas detector can be another type of detector, such as an optical detector, a radiation or radiation absorption detector or a surface sensor past which the carrier gas flow is directed. In the case of a mass spectrometric gas detector, it can be a quadrupole mass spectrometer. Any type of detector that generally requires a vacuum for gas detection, such as a mass spectrometric gas detector, is referred to here as a vacuum gas detector. To generate the required vacuum for the vacuum gas detector, a detector vacuum pump different from the test chamber vacuum pump can be provided, which can be a high vacuum pump system with a high vacuum pump, e.g. in the form of a turbomolecular pump, which evacuates the detector volume, and with a pre-vacuum pump which evacuates the high vacuum pump.

A first pressure gauge can be connected to the test chamber section of the first gas line between the first valve and the first flow throttle in order to measure the pressure in the test chamber section. A second pressure gauge can be connected to the detector section of the first gas line between the first connection point and the third flow throttle in order to measure the pressure in the detector section.

Depending on the measured pressures, the flow throttles D3, D4 and/or the valves V1, V2, V6 can be controlled.

The test chamber is preferably connected to a third pressure gauge for measuring the pressure in the test chamber, wherein the second throttle D2, the fourth throttle D4, the third valve V3, the fourth valve V4, the fifth valve V5 and/or the sixth valve V6 can be controlled depending on the measured pressure in the test chamber.

In the following, two exemplary embodiments of the invention are explained in more detail with reference to the Figures. The figures each show schematic illustrations of a carrier gas leak detection system.

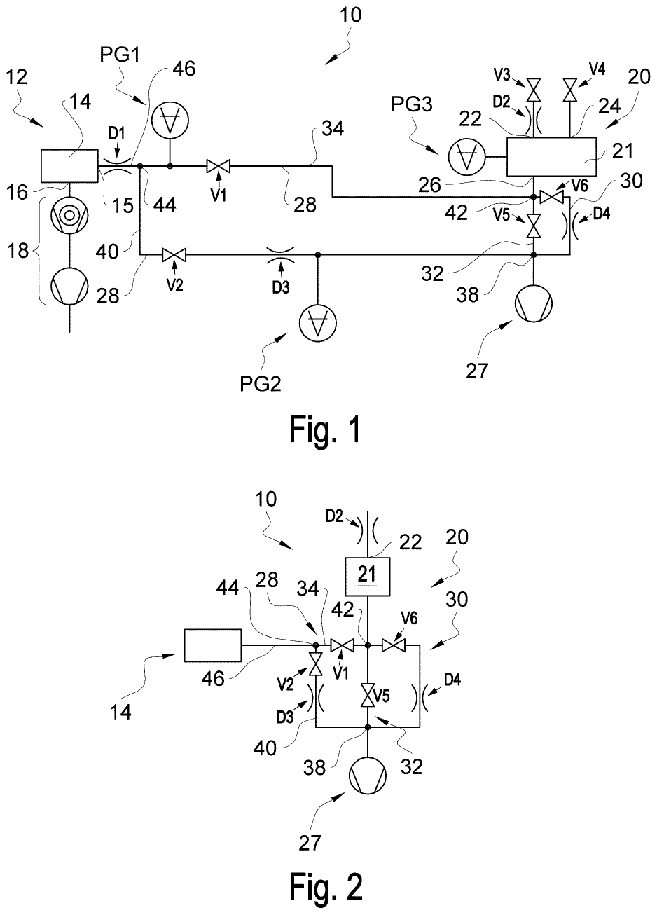

The carrier gas leak detection system 10 of the exemplary embodiment shown in FIG. 1 is a mass spectrometric carrier gas leak detection system comprising a mass spectrometric gas detector 12 in the form of a quadrupole mass spectrometer having a detector volume 14, a detector volume inlet 15 opening into the detector volume 14 and a detector volume outlet 16 opening into the detector volume 14. A detector vacuum pump 18 is connected to the detector volume outlet 16 in order to evacuate the detector volume 14. The detector vacuum pump 18 consists of a turbomolecular pump and a pre-vacuum pump. In a known manner, the inlet of the turbomolecular pump is connected to the detector volume outlet 16, while the outlet of the turbomolecular pump is connected to the inlet of the pre-vacuum pump. The outlet of the pre-vacuum pump can be open to the atmosphere.

The detector volume inlet 15 is provided with a first flow throttle D1 for pressure conversion at the detector volume inlet 15. The detector volume inlet 15 is connected to the test chamber outlet 26 by a first gas line 28.

The leak detection system 10 further comprises a test chamber 20 having a test chamber volume 21, a first test chamber inlet 22 opening into the test chamber volume 21, a second test chamber inlet 24 opening into the test chamber volume 21, and a test chamber outlet 26 also opening into the test chamber volume 21. The test chamber outlet 26 is connected to the first flow throttle D1 and the detector volume inlet 15 via the first gas line 28 in a gas-conducting manner.

The section of the first gas line 28 connecting the test chamber outlet 26 to the detector volume inlet 15 is referred to here as test chamber section 34. The section of the first gas line 28 connecting the detector volume inlet 15 to the test chamber vacuum pump 27 is referred to here as detector section 40.

A second gas line 30 also connects the test chamber outlet 26 with the test chamber vacuum pump 27, wherein the second gas line 30 runs parallel to the first gas line 28 and thus forms a bypass for the first gas line 28. The second gas line 30 is connected to the first gas line 28 and to the gas inlet of the test chamber vacuum pump 27 in a gas-conducting manner at a first connection point 38.

The first gas line 28 comprises a selectively closable first valve V1 in its test chamber section 34 and a selectively closable second valve V2 in its detector section 40. Between the second valve V2 and the first connection point 38, the first gas line 28 comprises a third flow throttle D3 with a predetermined or adjustable conductance S3.

Between the test chamber outlet 26 and the first connection point 38, the second gas line 30 comprises a fourth flow throttle D4 with a predetermined or adjustable conductance S4, wherein the second gas line 30 has a selectively closable sixth valve V6 between the fourth flow throttle D4 and the test chamber outlet 26.

The test chamber outlet 26 is also connected to the test chamber vacuum pump 27 in a gas-conducting manner via a third gas line 32, the third gas line 32 being connected in a gas-conducting manner to the first gas line 28 and the second gas line 30 at a second connection point 42 at the test chamber outlet 26. The third gas line 32 bridges the first gas line 28 and the second gas line 30 between the first connection point 38 and the second connection point42 and includes a selectively closable fifth valve V5. The first, second and third gas lines 28, 30, 32 are connected to each other and to the gas inlet of the test chamber vacuum pump 27 at the first connection point 38 in a gas-conducting manner.

Between the first flow throttle D1 and the first valve V1, the first gas line 30 is connected to a first pressure gauge PG1 in its test chamber section 34. The detector section 40 is connected to a second pressure gauge PG2 between the third flow throttle D3 and the first connection point 38.

The test chamber 20 is connected in a gas-conducting manner to a third pressure gauge PG3 in the form of a total pressure sensor for measuring the pressure in the test chamber 20. The first test chamber inlet 22 comprises a second flow throttle D2 with a predetermined or adjustable conductance S2 for supplying carrier gas and a selectively closable third valve V3. The second test chamber inlet 24 has a selectively closable fourth valve V4 for flushing and/or ventilating the test chamber volume 21.

The section of the first gas line 28 connecting the first connection point 38 to the gas inlet 15 and the first flow throttle D1 is referred to as detector section 40. The detector section 40 contains the second valve V2 and the third flow throttle D3 and is connected to the second pressure gauge PG2. At the first connection point 38, the detector section 40 is connected to the second gas line 30, the third gas line 32 and the gas inlet of the test chamber vacuum pump 27 in a gas-conducting manner.

The detector volume 14 of the gas detector 12 is evacuated in a known manner by the detector vacuum pump 18, so that a suitable high vacuum pressure prevails inside the detector volume 14. In order to test the tightness of a test specimen not shown in the figure, it contains a fluid test medium and is introduced into the test chamber 20. The test medium can be a test gas or a test liquid, the vapor phase of which is used to detect a leak. The test chamber 20 is then evacuated by the test chamber vacuum pump 27 with valve V5 open. As soon as a suitable pressure is reached in the test chamber 20, the fifth valve V5 is closed.

By opening the sixth valve V6 and the third valve V3, the test chamber vacuum pump 27 draws carrier gas through the second flow throttle D2 into the test chamber volume 21 and supplies it through the test chamber outlet 26 along the second gas line 30 through the fourth flow throttle D4 to the test chamber vacuum pump 27 as the first partial flow. After opening the first valve V1 and the second valve V2, a second partial flow of the carrier gas transported through the test chamber 20 is supplied along the first gas line 28 past the detector inlet 15 and through the detector section 40 through the third flow throttle D3 to the test chamber vacuum pump 27. By suitably adjusting the conductance of the flow throttles D3, D4, a flow division is achieved such that the first partial flow is significantly greater than the second partial flow along the detector inlet 15.

From the second partial flow, carrier gas with possible leakage gas passes from the test specimen through the first flow throttle D1 into the detector volume 14, where it is analyzed. For this purpose, the first gas line 28 is connected to the gas detector 12 at a third connection point 44 connecting the test chamber section 34 to the detector section 40 with a short line section 46 of the detector volume gas inlet 15. Alternatively, in another exemplary embodiment not shown in the figures, the first gas line 28 may be connected at the third connection point 44 to a gas detector 12 of a different type.

By adjusting the conductance of the second flow throttle D2, the carrier gas flow is adapted to the test chamber volume 21 or the gas volume in the test chamber 20. If the suction capacity of the test chamber vacuum pump 27 remains the same and/or the suction capacity effectively acting via the throttles D3 and D4 remains the same, a changed carrier gas flow leads to a changed equilibrium pressure within the test chamber 20. To prevent the changed test chamber pressure from also changing the pressure inside the detector volume 14, the suction capacity of the test chamber vacuum pump 27 is adapted to the desired inlet pressure at the detector volume inlet 15 by adapting the conductance of the fourth throttle D4. The third flow throttle D3 is then used to adapt the partial flow ratio of the two partial flows supplied to the test chamber vacuum pump 27 in such a way that a defined second partial flow is guided along the detector volume inlet 15, while the main part of the carrier gas flow is guided directly to the test chamber vacuum pump 27 as the first partial flow.

The detector volume 14 is permanently pumped via the detector vacuum pump 18.

### Measuring Procedure:

| No. | Designation | V1 | V2 | V3 | V4 | V5 | V6 |
|---|---|---|---|---|---|---|---|
| 1 | standby, test | closed | open | closed | open | closed | closed |
| | chamber open | | | | | | |
| 2 | priming the test | closed | closed | closed | closed | open | open |
| | chamber | | | | | | |
| 3* | start carrier gas | closed | closed | open | closed | closed | open |
| 4 | measuring, with | open | open | open | closed | closed | open |
| | flow division | | | | | | |
| 5 | complete | closed | closed | closed | open | closed | closed |
| | measurement | | | | | | |
| | corresponds to | | | | | | |
| | no. 1 | | | | | | |

*point 3 can also be skipped

During measuring operation, the carrier gas flows into the test chamber 20 via valve V3. The strength of the carrier gas flow is defined by the throttle D2. Downstream behind the test chamber 20, the carrier gas flow splits into two parts at the second connection point 42. The larger portion is guided directly to the test chamber vacuum pump 27 via V6 and throttle D4 through the second gas line 30. The second smaller part of the flow flows along the first gas line 28 through the first valve V1 and along the detector section 40 through the valve V2 and throttle D3 to the same test chamber vacuum pump 27. The flow through the throttle D1 into the detector volume 14 is negligibly small compared to the carrier gas flow.

The sum of the suction capacity/conductance of the two flow throttles D3 and D4, the partial flows of which are combined at the first connection point 38, are selected such that the desired equilibrium pressure is achieved in the test chamber 20 at the selected carrier gas flow (defined via throttle D2).

The following applies:

$$P = Q / S with S = S 3 + S 4$$

Q: carrier gas flow
S: conductance of throttles (equivalent to the suction capacity, which is limited by the throttles)
S3: conductance of throttle D3
S4: conductance of throttle D4
P: equilibrium pressure in the test chamber.

The decision-making chain for the interpretation of the parameters is as follows: The carrier gas flow is specified. The flow is selected such that the amount of gas in the net volume of the test chamber 20 is exchanged as completely as possible in a short time.

In doing so, the carrier gas flow rate should not be set too high so as not to dilute the test gas too much.

For applications with a larger net volume of the test chamber 20, the pressure is reduced to a lower level so that the amount of gas to be exchanged with the carrier gas is lower. The pressure is not set too low so that a simple, inexpensive pump can also be used as a test chamber vacuum pump. The equilibrium pressure is adjusted by means of the throttles D3 and D4.

The ratio of the conductance of the throttles D3 and D4 is selected such that a sufficiently fast gas exchange in the first gas line 28 at the detector volume inlet 15 to the detection system of the gas detector 12 (path V1=>V2=>D3) is ensured.

The exemplary embodiment shown in FIG. 2 differs from the exemplary embodiment shown in FIG. 1 substantially in the type and length of the routing of the first and second gas lines 28, 30 and in that the gas detector 14 is not necessarily a mass spectrometric gas detector. Rather, the gas detector 14 can be any conceivable type of gas detector, in particular an optical gas analyzer, for example based on the principle of radiation analysis or infrared adsorption, or a gas detector having a surface sensor, along the surface of which the second partial flow is guided.

The illustration of the line routing in FIG. 2 makes it clear that the first gas line 28 forms with the test chamber section 34 and the detector section 40 a common gas line path connecting the two connection points 42, 38, which runs between the two connection points 42, 38 parallel to the gas line path formed by the second gas line 30.

The line section 46 of the detector inlet 15 between the detector volume 14 and the third connection point 44 is to be kept short. In this way, the carrier gas flow passing through the third connection point 44 ensures rapid gas exchange at the detector. In particular, the line section 46 is shorter than the first gas line 28, than the second gas line 30, than the detector section 40 and than the test chamber section 34.

A further difference between the exemplary embodiment according to FIG. 2 and the exemplary embodiment according to FIG. 1 is that the pressure gauges PG1, PG2, PG3, the second test chamber inlet 24 with the fourth valve V4, the third valve V3 and the flow throttle D1 are not shown in FIG. 2. Nevertheless, one or more of these components can be provided in the exemplary embodiment shown in FIG. 2. Accordingly, it is also conceivable that the valves V1, V2, the second flow throttle D2 and/or the third gas line path 32 with the fifth valve V5 are omitted in the exemplary embodiment in FIG. 2. Depending on the type of application and detector type, it is also conceivable that one or more of the valves V1, V2, V6 are omitted.

1-15. (canceled)

16. A carrier gas leak detection system for leak detection on a test specimen, comprising:
a gas detector;
a test chamber having at least a first test chamber inlet, a test chamber outlet and a test chamber vacuum pump evacuating the test chamber outlet;
a first gas line connecting the test chamber outlet to the detector volume inlet and the test chamber vacuum pump in a gas-conducting manner;
a second flow throttle for presetting the carrier gas flow through the first test chamber inlet;
a second gas line connecting the test chamber outlet to the test chamber vacuum pump parallel to the first gas line, the first gas line and the second gas line being connected to the test chamber vacuum pump in a gas-conducting manner at a first connection point;
a third flow throttle in a detector section of the first gas line between the first con-nection point and the detector volume inlet; and
a fourth flow throttle in the second gas line between the test chamber outlet and the first connection point;
wherein the third flow throttle and the fourth flow throttle form a flow divider such that a first partial flow through the first gas line and a second partial flow through the second gas line can be evacuated from the test chamber using the test chamber vacuum pump.

17. The carrier gas leak detection system according to claim 16, wherein the conductance S3 of the third throttle is lower than the conductance S4 of the fourth throttle.

18. The carrier gas leak detection system according to claim 16, wherein a test chamber section of the first gas line between the test chamber outlet and the detector volume inlet comprises a selectively closable first valve and the detector section comprises a selectively closable second valve between the first flow throttle and the third flow throttle.

19. The carrier gas leak detection system according to claim 16, wherein the first test chamber inlet is provided with a selectively closable third valve.

20. The carrier gas leak detection system according to claim 16, wherein the test chamber comprises at least one second test chamber inlet for ventilating or flushing the test chamber with a selectively closable fourth valve.

21. The carrier gas leak detection system according to claim 16, wherein the test chamber outlet is connected to the test chamber vacuum pump by a third gas line via the first connection point, the third gas line being provided with a selectively closable fifth valve and being arranged parallel to the first and second gas lines.

22. The carrier gas leak detection system according to claim 16, wherein the second gas line comprises a selectively closable sixth valve.

23. The carrier gas leak detection system according to claim 16, wherein the gas detector comprises a detector volume, a detector volume inlet having a first flow throttle for pressure conversion at the detector volume inlet, a detector volume outlet and a detector vacuum pump at the detector volume outlet.

24. The carrier gas leak detection system according to claim 16, wherein the gas detector is a mass spectrometer and the detector vacuum pump is a high vacuum pump system with a turbomolecular pump and a pre-vacuum pump.

25. The carrier gas leak detection system according to claim 24, wherein the mass spectrometer comprises a quadrupole mass spectrometer.

26. The carrier gas leak detection system according to claim 16, wherein the detector vacuum pump is a high vacuum pump system with a turbomolecular pump and a pre-vacuum pump.

27. The carrier gas leak detection system according to claim 16, wherein a first pressure gauge is connected to the first gas line between the first valve and the first flow throttle for measuring the pressure in the first gas line.

28. The carrier gas leak detection system according to claim 16, wherein a second pressure gauge is connected to the detector section between the first connection point and the third flow throttle for measuring the pressure in the first gas line.

29. The carrier gas leak detection system according to claim 16, wherein the test chamber is connected to a third pressure gauge for measuring the pressure in the test chamber.

30. A carrier gas leak detection method for leak detection on a test specimen with a carrier gas leak detection system according to claim 16, comprising:
introducing a test specimen into the test chamber;
evacuating the test chamber with the test chamber vacuum pump;
supplying carrier gas into the test chamber containing the test specimen through the second flow throttle;
evacuating the second gas line with the test chamber vacuum pump;
specifying the conductance of the third flow throttle and the fourth flow throttle as a flow divider such that a first partial flow through the second gas line and a second partial flow through the first gas line can be evacuated from the test chamber using the test chamber vacuum pump; and
analyzing gas from the second partial flow with the gas detector.

31. The carrier gas leak detection method according to claim 30, wherein the gas detector comprises a detector volume and a detector vacuum pump, the detector vacuum pump evacuating the detector volume to a vacuum pressure required for gas detection.

32. The carrier gas leak detection method according to claim 30, wherein the gas flow along the first partial flow is greater than along the second partial flow.
